(19) United States
(12) Patent Application Publication
(10) Pub. No.: US 2004/0089209 A1
(43) Pub. Date: May 13, 2004

(54) Levelling wheel and closing wheel used in no-till sowing

(76) Inventor: Jorge Carlos Joaquin Romagnoli, Monte Buey - Cordoba (AR)

Correspondence Address: NOTARO AND MICHALOS, 100 DUTCH HILL ROAD, SUITE 110, ORANGEBURG, NY, 10962-2100, US

(21) Appl. No.: 10/679,600

(22) Filed: Oct. 6, 2003

(30) Foreign Application Priority Data
Apr. 18, 2002 (AR) P 020101331

(51) Int. Cl. A01C 7/00

(52) U.S. Cl. 111/185

(57) ABSTRACT

A tandem comprising the combination of leveller and covering wheels for use in no-till or direct-till sowing machines. The leveller wheel (11B) has a semipneumatic tread (15B) including a cavity (31) next to the furrow opener disk (55) to make room for the soil removed from the ground by the latter without compacting it. The cavity spans between one- and two-thirds the breadth of the tread. The shape of the cavity follows the profile naturally formed by the elevated rib of soil formed on the ground on which the covering wheel (35) operates. The cross-section area of the cavity is 30% greater than that of the deepest expected furrow. The covering wheel is provided with conical studs (45) which radially project outwards from the tread (39), at a 5° angle to the wheel plane, the flat rolling band being slanted at 30° to the horizontal.

### FIELD OF THE INVENTION

The present invention is related to a levelling wheel and a closing wheel used in agricultural machines, more particularly in sowing machines and no-till seed planters. “No-till” is understood to be the sowing system in which the sowing bed is not previous tilled, that is to say, the soil is worked without ploughing and in whatever conditions it is found, whether on uneven terrain or without cleaning the mulching of a previous harvest.

It is known for no-till sowing machines to include a chain of implements pulled by a tractor. The chain of implements includes a variety of sowing sets equidistantly distributed across the machine according to the number of sowing lines that the machine has. Altough the designs of the above refered sets may differ according to different manufacturers, models, soil properties, etc., in general they are classified as monodisk and bidisk furrow openers. The first include a furrow-opener disk with a 7 degree leading angle in the travel direction, a levelling wheel next to the opening disk, a tube down which the seed flows into the furrow opened by the furrow opener disk, a seed stepping wheel right behind that enters the furrow to lay the seed at the bottom of the furrow and a closing wheel ending the set which crumbles and presses the soil of the side-wall of the furrow, covering the seed and levelling the surface. In the bidisk opener, the elements are the same, only that the following parts are paired: the furrow opening disk, the levelling and closing wheels, with a 4 degree leading angle in each disk.

The present invention is applicable to either kind of no-till machines. The levelling wheel is coaxial with the opener disk and its axle is linked to the opener disk by bolts with adjustable positions. The levelling wheel includes a bearing band that, when rolling over the soil adjacent to the furrow to be opened, transfers to the axle of the levelling wheel a reference of the soil level to adjust the depth on the furrow, usually according to the kind of seed. The levelling wheel is placed slightly angled both to the travel direction of the set and to the vertical so that it pushes the soil back into the furrow to cover the seed placed into it.

### BACKGROUND OF THE INVENTION

To cope with different soil conditions, changes are made by users to the original configuration of the sowing equipment so as to minimize the negative effects of the levelling and covering wheels. Also, some sowing machines of Brazilian origin provide their kits with devices to separate the levelling wheels of the furrow opener disk to reduce undesirable effects of the levelling wheels attached to the disk under specific working conditions.

The separation of the levelling wheel from the disk in approximately two to four centimetres, avoids compression of the soil next to the sowing furrow, but it produces an important disturbance on the soil surface, due to the fact that the soil sticks to the disk, half burying the mulch that leaves the tilled sowing line and without mulch, increasing the drying out and putting germination under risk, increasing the possibility of flattening and crusting due to a later rain, thus being emergence more difficult.

In the USA there are sowing machines with semipneumatic levelling wheels (International Harvester, Part Nbr. I. H. 128633-C1) that have a treading band with a depressed side, but under load during work, the depression is crushed under the load supported by the treading band. The following drawings illustrate the present state of the levelling wheels used in conventional sowing machines: FIG. 1A is a transversal cut that shows the lower part of a conventional levelling wheel.

FIG. 1B is a cross-section showing the effect under load of the levelling wheel of the FIG. 1A.

FIG. 3A is a cross-section showing the lower part of a furrow-opener monodisk set supplied with the levelling wheel of FIG. 1A.

FIG. 4A is a cross-section similar to FIG. 3A but showing a conventional bidisk set.

The conventional levelling wheel 11A illustrated in FIG. 1A includes a 13 tire rim and in its perimeter a 15A treading band is fitted supplied with a 17A contact surface to be in contact with soil 19, as it is shown in FIG. 2A. The 15A treading band may be solid as well as psemineumatic; in the latter case it has got an 21 internal toroidal hollow to absorb soil surface irregularities and mulching besides 23A internal chords and soften vibrations transmitted to the 25 furrow-opener disk due to those irregularities.

Levelling wheels with conventional features are described in FIG. 1 of the U.S. Pat. No. 6,119,608—monodisk set—and in FIG. 2 of the U.S. Pat. No. 5,904,107—bidisk set, for example.

The 17A contact surface covers almost all the width of the 11A levelling wheel with the purpose of maximising the copying of the soil level 19 and ironing out unevenness thereof, as illustrates the FA load distribution represented in FIG. 2A. FIG. 3A shows the set made up by the above mentioned 11A levelling wheel fitted to furrow-opener disk 25. The soil removed by this is pressed by the levelling wheel 11A, resulting in a furrow 29 with a pressed soil wall 27A where the seeds are stuck, and in the germination precess, water is absorbed and; therefore, the size is increased, thus getting stuck to the side walls. Since the effective contact band on the soil is extended on a flat way or with minimum depressions all along the width of wheel 11A, the latter generates wall compression of the sowing furrow, reducing the porous space of the soil and increasing density. This effect is more serious in soils with optimum, slimy and clay texture and also with the increase in the soil humidity, making soil-seed contact, germination and later seedling emergence difficult, with its subsequent irregularities in plant development and loss of productivity.

FIG. 4A illustrates the same problem as FIG. 3A but referred to a bidisk set that some machines employ, especially planters.

The possibility of adding grooved disks to levelling wheels to loosen and crumble soil previously compacted by levelling wheels is a common proposal of planters and devices for no-till manufacturers and, obviously, it helps to minimize undesirable consequences of flat levelling wheels fitted to the disk, but they do not solve the problem of how compression originates.

The covering wheel that comes behind normally presents a cylindrical treading band to replace in the furrow 29 the soil removed by disk 25, covering seeds placed in it. The covering wheel that most planters and seeders have available in the market are slanted, with a 20° angle from its axle respect to the horizontal and a 3° respect to moving direction, such slanted position gives an attack degree needed for the function it carries out.

However, the already mentioned compression 27A makes the function of the covering wheel difficult, giving as a result an incomplete soil replacement which reduces emergence success.

On the other hand, the already known and available covering wheels in the market, either psemineumatic or solid, made of rubber or iron, with round or trapezoidal profile, lack elements that can perform well with lots of mulching while placing and crumbling soil adequately around the seed. The American patent also illustrates another covering wheel in FIG. 3, in its treading band a groove has been invented to promote penetration into the compacted soil and improve furrow covering 29.

### BRIEF DESCRIPTION OF THE INVENTION

Prior to this invention, the inventor had discovered the problem of soil compression in sowing lines and had tried primitive solutions. See his paper on “Maquinarias en Siembra Directa” presented by Jorge C. Romagnoli at the “1er Congreso Nacional de Siembra Directa”, AAPRESID, Villa Giardino, Cordoba Province, Argentina, Mar. 25th to 28th, 1992. The disclosed prototype was made of solid wood and continued to be developed, leading to further improvements according to the present invention, after including experimentation in the field and consideration of practical applications in different soil working conditions.

The invention includes a tandem of levelling and covering wheels for sets mounted on a planting train pulled by a tractor. One of the objects of the invention was to obtain a levelling wheel that could copy the actual level of the soil, avoiding as possible the interference of harvest residues. Another object of the invention is to make the mulching cut easier by means of the furrow-opener planting disk.

A fundamental object of the invention is a levelling wheel that avoids compressing the soil moved aside by the disk, making the seed placement and furrow covering by means of the covering wheel easier. The main aspect of the present invention is a levelling wheel supplied with an asymmetrical treading band to make room for the soil pushed aside by the disk, so as to avoid compressing it as much as practical. In this way, an adjacent gap is provided in the wheel for the unearthed soil, without detriment to the function of copying the soil level to determine the depth of the open furrow by the neighbouring disk.

The treading band of the levelling wheel of the invention is semipneumatic and is provided with a depressed area on the side next to the furrow-opener device, thereby forming an alveolus for recieving almost all the soil removed by the furrow opener, considering that the volume of decompressed soil put aside is greater than in its original state prior to the opening of the furror.

Thus, the furthest part of the treading band of the furrow-opener is the treading surface in itself, which is generally cylindrical so that at all times the lower part thereof has a relatively transversally-flat surface in contact with the soil, while the part of the band closer to the disk does not contact the soil level itself but receives the soil removed from the furrow as it is being opened.

This depression or alveolus can cover around one- or two-thirds of the treading band of the levelling wheel, depending on the features and models of furrow-opener disks, the load on the wheel and the bearing properties of the soil on which it operates. The depression opens towards the disk, preferably following a form copying the shape that the upraised rib of soil adopts on which the covering wheel will operate.

The transversal area of this depression should be related to and greater than the transversal area of the furrow opened by the furrow-opener disk, say 30% more than the average expected sowing depth, due to the fact that the removed soil occupies a larger volume in about that percentage. Obviously, when the depth is less, there is no space limit and the wheel performance is not affected.

The treading band is also resilient enough to avoid wet soil sticking and to compensate uneven terrain.

According to another aspect of the present invention, a covering wheel is designed for both operating in tandem with the above mentioned levelling wheel in no-till sowing or else independently in other planting machines for conventional sowing. The object of the covering wheel is to take advantage of the little or minor compression of the soil available at the side of the furrow to replace it into the furrow and cover the seeds. This action is performed by a flat treading band which is slanted to the horizontal, which compresses the soil when it is loose and with low humidity. The covering wheel of the present invention is provided with a series of radial conical studs projecting radially outwards, preferably at a slightly slanted angle to the wheel plane (which is perpendicular of its axle), for breaking up clods and properly pressing the soil over the sowing line, leaving a slight ridge of furrow of loose soil on the surface and at the same time operating on thick or thin mulching to close the sowing furrow in any condition normally met in practice. The slant of the flat treading band is slightly greater than the conventional; forming a 30° angle in relation to the horizontal which could be slightly greater or smaller without affecting its performance, whereas the height and diameter at the base of the studs are in relation to the width of the treading band. The studs may have an angle of about 5° measured between the axis of the cone in relation to the wheel plane.

### BRIEF DESCRIPTION OF THE DRAWINGS

The above-stated and other novel features and aspects of this invention and how it may be reduced to practice may be better understood from the following detailed description of a preferred embodiment shown in the attached drawings, wherein:

FIGS. 1A, 2A, 3A and 4A illustrate conventional levelling wheels available on the market as described hereinabove.

FIG. 1B is a cross-section of the lower part of the levelling wheel according to the present invention.

FIG. 2B is a cross-section showing performance under load of the levelling wheel of FIG. 1B.

FIG. 3B is a cross-section showing the lower part of a furrow-opener monodisk set supplied with a levelling wheel of FIG. 1B.

FIG. 4B is a cross-section similar to FIG. 1B but showing a bidisk set, where each furrow-opener disk is supplied with a levelling wheel according to the present invention.

FIG. 5 is an axial section of a covering wheel according to the present invention.

FIGS. 6A and 6B illustrate respective cross-sections A-A and B-B taken from FIG. 5.

FIG. 7 is a schematical perspective view of a monodisk sowing set fitted with the levelling and covering wheels of the present invention.

### DESCRIPTION OF THE PREFERRED EMBODIMENTS

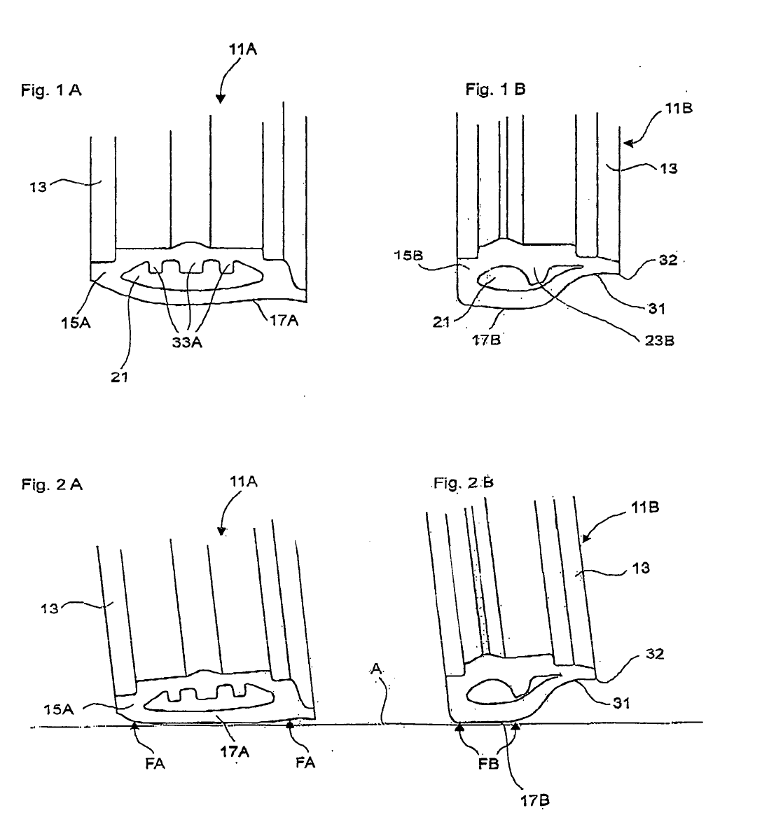

The structure and construction of the desired model of the levelling wheel 11B of the present invention is illustrated in FIG. 1B. The levelling wheel 11B contains a conventional tire rim 13 in which perimeter a psemineumatic treading band 15B is fitted. The width of the levelling wheel 11B may be between 65 and 115 mm, preferably between 90 and 100 mm for most machines available in the market. The treading band 15B has an inside toroidal hollow 21 to absorb unevenness of the terrain and mulching. The treading band has an inner rib to bear vibrations transmitted to the furrow opener 25 due to uneven surfaces of the terrain and bound a treading band per se17B on its inner side.

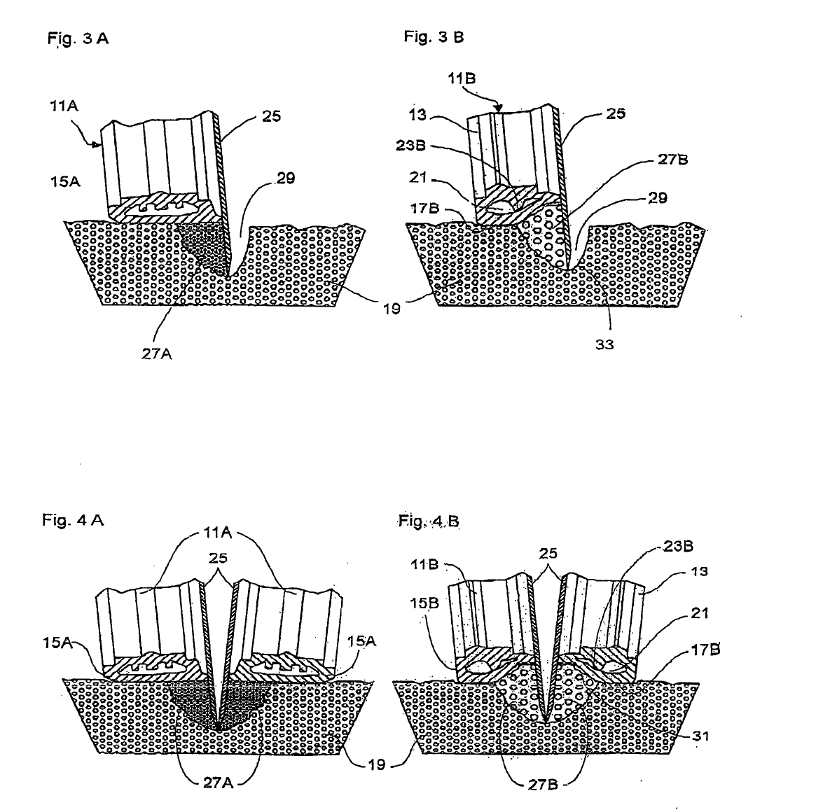

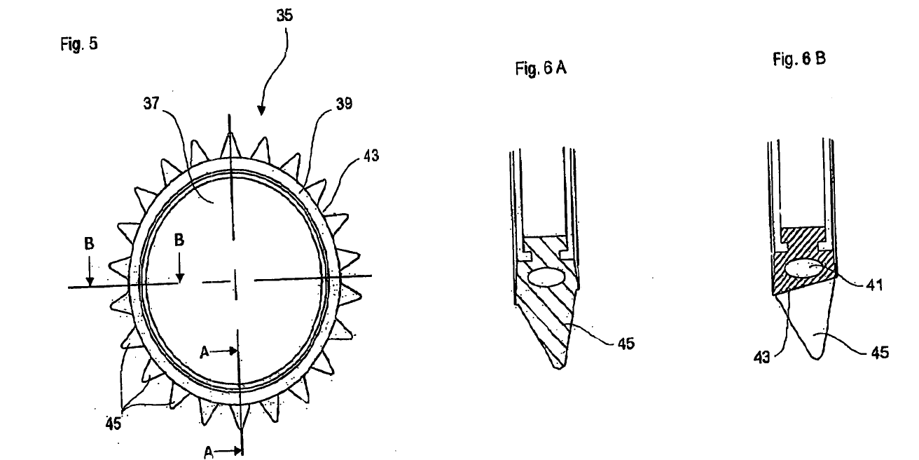

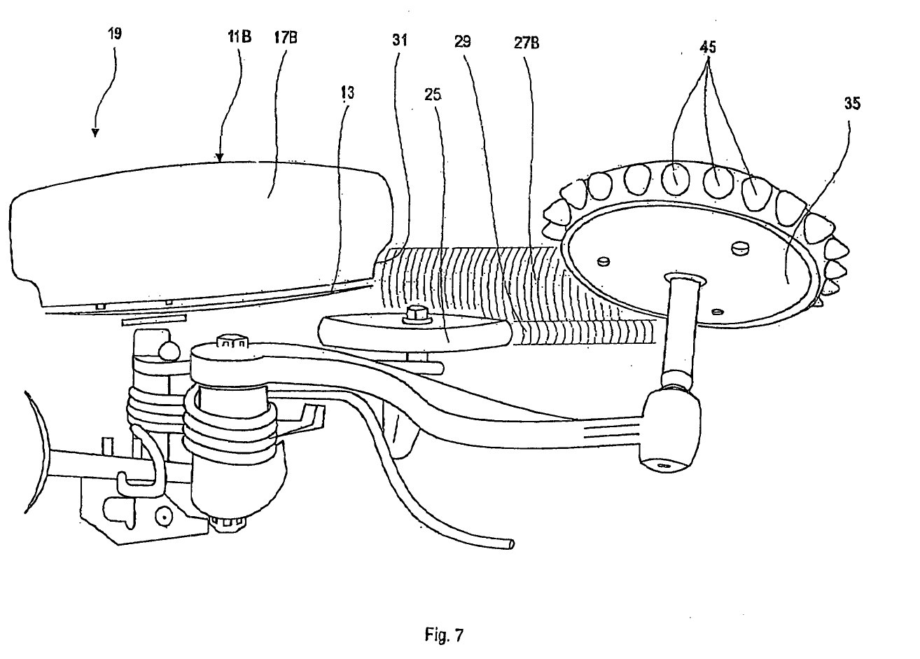

A perimetral area of the treading band 15B is made up of the contact surface 17B—or treading surface in itself—to contact soil 19 and receive the load state Fb represented in FIG. 2B, able to generate a pressure that fluctuates between 1 and 2 kg/sq cm. If the pressure is too weak (less than 0,8 kg/sq.cm.), the porous characteristic of the mulch makes the wheel 115 lose contact with the soil 19 modifying the seed depth at random according to the type and thickness of vegetation residues that sometimes cover the soil surface. The other perimetral area of the treading band 15B, which in the assembling stage is fitted next to the furrow-opener 25 as illustrated in FIG. 3B, shows an alveolar depression 31 in all its perimeter, with a width and depth enough to house all the residue and soil left aside 27B by the furrow opener disk 25 for a medium-major sowing depth, approximately 5 cm. From there the treading surface 17B per se joins depression 31 displaying a typical bell-shaped or sine-wave form that has to do with the shape naturally adopted by the upraised ridge remains of the open soil of the furrow on which the covering wheel will operate, reaching the maximum depth of depression or alveolus 41 prior to finishing off in a clearing tab 32 bearing against the furrow-opener disk 25.

Use on a no-till planter generates an upraised loose soil strip 27B on the side of the furrow 29, facilitating the closure of the furrow following sowing of the seed at the furrow bottom, even in soils with a humidity higher than desired. It helps disk 25 to cut the mulch when the distance between the cutting edge 33 and the soil surface 27B is increased which raises when it is put aside. By the same principle, the disk edge 25, when it rotates and comes out of the furrow 29, pulls out semi-buried mulching residues, leaving it with less residue and thus improving soil-seed contact. Reducing the width of the contact band 17B on the natural soil 19 (FIG. 2B), the possibility of stub, cane, etc. interference from previous harvest is equally decreased, which affects proper copying of the soil as well as uniformity in sowing depth, thus improving its control. All this is carried out by the depressed profile of a side area 31 of the treading band in all the perimeter of the levelling wheel 11B, that allows that, during the sowing task, the soil volume 27B left aside by the furrow-opener disk 25 is placed under the levelling wheel 11B without being pressed, avoiding in this way the undesirable effects already mentioned that result from the levelling wheel 11A, even in soils with excessive humidity. The shape, place and size of alveolar depression 31 in the treading band is determined in such a way that the soil volume 27B left aside is not greater than the room provided by the depression of the wheel 11B and the width of the treading band in itself 17B so that the resulting load generates a pressure on the soil between 1 and 2 kg/sq.cm. in accordance with the model of the sowing set.

More precisely, the width of the treading band 15B is calculated according to the furrow-opener disk 25, as the width of the contact band 17B according to the load transmitted and depth and the width of the depressed band 31 according to the soil left aside by the furrow-opener disk plus a 30%, taking as a reference a medium working load Fb that could transmit a pressure on the soil 19 of 1.5 kg/sq.cm. and a soil movement that could carry out at the medium-major sowing depth—depending on type and design of the furrow-opener disk 25 and for the seed type that the seeder is prepared for—determined by the transversal area of the sowing furrow 29.

FIG. 5 is a schematic of a covering wheel 35 arranged in the sowing furrow behind the sowing pipe that follows the above mentioned furrow-opener set 25-11B. It has an iron tire 37 supplied with a treading band 39 of trapezoidal section supplied with an air hollow 41, as illustrated figure cut 6B. This trapezoidal section defines a slanted face 43 in relation to the horizontal with an optimum degree of 30°, without taking into account the anchoring angle of the covering wheel 35 axle with the mobile bearing included in the furrow-opener set of the sowing set. Conical studs 45 project from the treading band 39 in a radially even distribution around the entire circular perimeter that loosens and presses the soil 27B conveniently in the sowing line, forming a smooth furrow ridge on the surface over the seed deposited in the furrow 29, while operating on smooth or rough bulk residues, closing the sowing furrow in all possible soil conditions.

The number of conical studs 45 is related to the perimeter of the band 39 and its size, on its base and height, with the width of the same band 39 that at the same time correlates with the depressed treading band 31 of the levelling wheel 11B. The width of the band of the covering wheel 39 spans a proportion of 70% of the width of band 31 of the levelling wheel 11B. The number of studs that the treading band 39 has in its perimeter will result from the division of this into spaces that measure between 1.7 and 2 times the square root of the radius of the wheel 35. The base of the cone of the studs occupies around 90% of the treading band width 39 and the height of cone is within 1 and 1.2 times the base diameter.

The oval air hollow 41 gives enough resiliency to the treading band 39 and to the studs 45 to free them from soil stuck by humidity or vegetable residues that could tack between them. This is why its transversal area must be of 20-25% of the transversal area of the trapeze formed by the treading band.

It has been found by means of field samples that the radial conical studs 45 of the closing wheel 35 bring pressure on the potential soil clods or crust that could be originated by the furrow-opener disk 25 in a soil previously compacted, leaving it smooth and improving the seed-soil contact. In loose soil, the studs 45 easily penetrate, allowing the flat band 39 to make proper contact with the surface and applying enough pressure on the soil to avoid water loss that could affect germination. They can also work among abundant smooth and rough mulching and stalks, perfectly closing the the sowing furrow 29. It may be wet, loose or dry soil, hardened or covered by abundant smooth or rough mulching, the conical studs 45 in the treading band 39 crumble, press the soil and close the furrow 29 in different mulching amounts and volumes.

The above-described wheels 11B and 35 are also applicable as depth leveller and sowing furrow closer, respectively, not only in furrow-opener monodisk but also in the one illustrated in FIG. 7 as well as in the bidisk ones represented in FIG. 4B. In all cases, the shape and profile on the treading band 15B, 39 of both wheels 11B, 35 combined with the psemineumatic quality of the respective treading band 15B, 39. On the levelling wheel 11B, the treading band itself 17B (between one- and two-thirds of the width of the wheel 11B) steadily supporting on the soil 19e copies the latter level to determine sowing depth, while its pseminuematic composition gives enough resiliency to prevent wet soil adherence and absorb terrain unevennesses without transmitting vibrations to the sowing assembly that could disturb the seed distribution. In the covering wheel, the studs 45 with a conical shape form a suitable angle in relation to the wheel plane 35, with the height and diameter of the base in accordance with the treading band width 39 and the number of these contained in the perimeter, exert a favourable influence on hard soil with clods, excess humidity and abundant surface mulching, optimizing the sowing furrow closure in different soil conditions.

Of course, changes, variations and aggregations may be made to any of the above-detailed embodiments, without departing from the scope nor the spirit of the invention. The same has been described by way of preferred embodiments, however those skilled in the art may suit it to other applications or introduce modifications without departing from the purview of the invention as set forth in the appended claims.

What is claimed is:

1. A levelling wheel for use in direct sowing and fitted to a furrow-opener device for opening a furrow in the ground, the levelling wheel having a semipneumatic treading band for treading and copying the soil to determine a sowing depth, the treading band having a side area next to the furrow-opener disk, said side area having substantially the form of a depression forming an alveolus between the furrow-opener disk and the surface of the treading band of the levelling wheel that touches the soil, said depression adapted to receive soil pushed aside by the furrow-opener device.

2. The levelling wheel of claim 1, wherein said depression or alveolus is dimensioned in accordance with the soil pushed aside by the furrow-opener disk.

3. The levelling wheel of claim 2, wherein the soil pushed aside by the furrow-opener disk is considered in a substantially uncompressed state in dimensioning said depression or alveolus.

4. The levelling wheel of claim 3, wherein said depression is dimensioned such that the cross-section of said alveolus is about 30% greater than the cross-section of the soil pushed aside by the furrow-opener disk.

5. The levelling wheel of claim 1, wherein said depression or alveolus extends between one- and two-thirds of the width of said treading band of the levelling wheel.

6. The levelling wheel of claim 1, wherein said the profile of said treading band has a substantially cylindrical treading surface that progressively flattens off until it joins to a surface belonging to the maximum depth of such depression or alveolus adjacent said furrow-opener.

7. The levelling wheel of claim 6, wherein said profile of the treading band generally follows a sine-wave shape where the treading surface in itself joins the surface that belongs to the maximum depth of the depression or alveolus, terminating in a cleaning tab that leans against the furrow-opener disk on assembly.

8. The levelling wheel of claim 1, wherein said treading band has inner bearing chords.

9. The levelling wheel of claim 8, wherein said chords include at least one chord that limits the depressed side area and the surface of the treading band that bears on the soil.

10. The levelling wheel of of claim 1, wherein said treading band is sufficiently resilient to avoid wet soil getting stuck thereto and for absorbing terrain unnevenness.

11. A covering wheel used in either direct or pretilled sowing, the covering wheel including a treading band to push loose soil at the side of the open furrow into the furrow again onto the seed to promote germination and emergence, wherein said treading band is provided with a plurality of substantially conical studs projecting radially outwards from the treading band and evenly distributed in a circular array around the treading band.

12. The covering wheel of claim 11, wherein said the studs form an angle with the plane of the wheel and the height and diameter of said studs depend on the treading band width.

13. The covering wheel of claim 11, wherein said treading band is semipneumatic.

14. The covering wheel of claim 11, wherein said treading band has a trapezoidal cross-section.

15. The covering wheel of claim 11, wherein said treading band maintains a face at around 30% in relation to the horizontal; the number of studs resulting from dividing said treading band into spaces of about 1,7 and 2 times the square root of the radius of wheel 35, the base of the studs occupying around 90% of the treading band width and the cone height being between 1 and 1.2 times the base diameter.

16. A tandem comprising a covering wheel and a levelling wheel for use in direct sowing, the levelling wheel having a semipneumatic treading band for treading and copying the soil to determine a sowing depth, the treading band having a side area next to the furrow-opener disk, said side area having substantially the form of a depression forming an alveolus between the furrow-opener disk and the surface of the treading band of the levelling wheel that touches the soil, said depression adapted to receive soil pushed aside by the furrow-opener device; and
the covering wheel including a treading band to push loose soil at the side of the open furrow into the furrow again onto the seed to promote germination and emergence, wherein said treading band is provided with a plurality of substantially conical studs projecting radially outwards from the treading band and evenly distributed in a circular array around the treading band.
